(19) United States
(12) Patent Application Publication
(10) Pub. No.: US 2024/0405486 A1
(43) Pub. Date: Dec. 5, 2024

(54) Plug Connector With Shield Plate, Comprising a Spring Contact Element

(71) Applicant: ERNI INTERNATIONAL AG, Schaffhausen (CH)

(72) Inventors: Stefan Molitor, Waschenbeuren (DE); Stephen Kaminski, Salach (DE)

(73) Assignee: ERNI INTERNATIONAL AG, Schaffhausen (CH)

(21) Appl. No.: 18/802,777

(22) Filed: Aug. 13, 2024

Related U.S. Application Data
(63) Continuation of application No. PCT/EP2023/053220, filed on Feb. 9, 2023.

(30) Foreign Application Priority Data
Feb. 14, 2022 (DE) 10 2022 103 406.2

(51) Int. Cl. H01R 13/6594

(52) U.S. Cl. CPC H01R 13/6594

(57) ABSTRACT

A connector includes a connector housing and a shield plate arranged on an inner side of the connector housing. The connector housing has a plug opening, a recess on a side of the plug opening, and a web on a side of the recess facing an interior of the connector. The shield plate has a spring contact element with a fastening element. The fastening element is positioned in the recess and does not protrude from the recess. The fastening element abuts against the web in a non-plugged state of the connector and is spaced from the web in a plugged state of the connector.

### CROSS-REFERENCE TO RELATED APPLICATIONS

This application is a continuation of PCT International Application No. PCT/EP2023/053220, filed on Feb. 9, 2023, which claims priority under 35 U.S.C. § 119 to German Patent Application No. 102022103406.2, filed on Feb. 14, 2022.

### FIELD OF THE INVENTION

The present invention relates to connector and, more particularly, to a shielded connector with a connector housing and a shield plate.

### BACKGROUND OF THE INVENTION

Connectors are used to contact, for example, circuit boards. The connectors comprise a housing and several contact elements arranged therein. The housing comprises a plug opening via which the contact elements are accessible and can be contacted. A component to be connected to the circuit board comprises a mating connector that is inserted into the plug opening of the connector. The connector comprises a shield plate to shield the connector from external electromagnetic influences and/or to prevent electromagnetic radiation from penetrating from the connector into the environment. Typically, two shield plates are provided which are arranged on the oppositely disposed long sides of the connector housing. At least one of these shield plates is arranged on the inner side of the connector housing facing the contact elements.

EP 1 251 591 A2 describes a connector with shield plates. The shield plates are connected to a connector housing by way of latching connections. In particular, the latching connections are configured as latching hooks that engage in depressions in the connector housing.

However, such depressions are not configured for spring contact elements and would prevent the deflection of the spring contact elements. In addition, the latching hooks protrude beyond the connector housing. As a result, they are exposed to external mechanical influences.

### SUMMARY OF THE INVENTION

A connector includes a connector housing and a shield plate arranged on an inner side of the connector housing. The connector housing has a plug opening, a recess on a side of the plug opening, and a web on a side of the recess facing an interior of the connector. The shield plate has a spring contact element with a fastening element. The fastening element is positioned in the recess and does not protrude from the recess. The fastening element abuts against the web in a non-plugged state of the connector and is spaced from the web in a plugged state of the connector.

### BRIEF DESCRIPTION OF THE DRAWINGS

Embodiments of the invention are illustrated in the drawings and shall be explained in more detail in the following description, wherein:

FIG. 1 shows an isometric view of a connector according to the invention according to a first embodiment;

FIG. 2 shows an isometric sectional view of the connector from FIG. 1 in a non-plugged state of a mating connector;

FIG. 3 shows an isometric sectional view of the connector from FIG. 1 in the plugged state of a mating connector;

FIG. 4a shows an isometric view of a connector according to a second embodiment;

FIG. 4b shows a detailed view from FIG. 4a;

FIG. 5 shows an isometric sectional view of the connector from FIG. 4a in the non-plugged state of a mating connector;

FIG. 6 shows an isometric sectional view of the connector from FIG. 4a in the plugged state of a mating connector;

FIG. 7a shows an isometric view of a connector according to a third embodiment;

FIG. 7b shows a detailed view from FIG. 7a;

FIG. 8a shows an isometric view of a connector according to a fourth embodiment; and

FIG. 8b shows a detailed view from FIG. 8a.

### DETAILED DESCRIPTION

The accompanying drawings are incorporated into the specification and form a part of the specification to illustrate several embodiments of the present invention. These drawings, together with the description, explain the principles of the invention. The drawings are merely for the purpose of illustrating examples of how the invention can be made and used and are not to be construed as limiting the invention to only the illustrated and described embodiments. Furthermore, several aspects of the embodiments may form-individually or in different combinations-solutions according to the present invention. The following described embodiments thus can be considered either alone or in an arbitrary combination thereof.

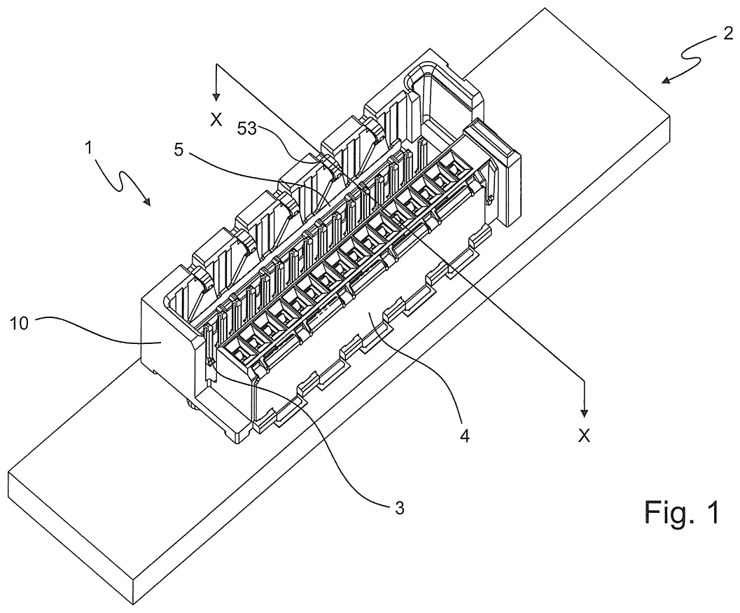

FIG. 1 shows an isometric view of a first embodiment of connector 1 according to the invention which is fastened to a circuit board 2 as an SMD (surface-mounted device). Connector 1 comprises a plurality of contact elements 3 which are contacted via circuit board 2. In addition, connector 1 comprises a connector housing 10 that, on an upper side, opposite the circuit board, has a plug opening through which contact elements 3 are accessible from the outside. The contact elements 3 are arranged in an interior of the connector housing 10.

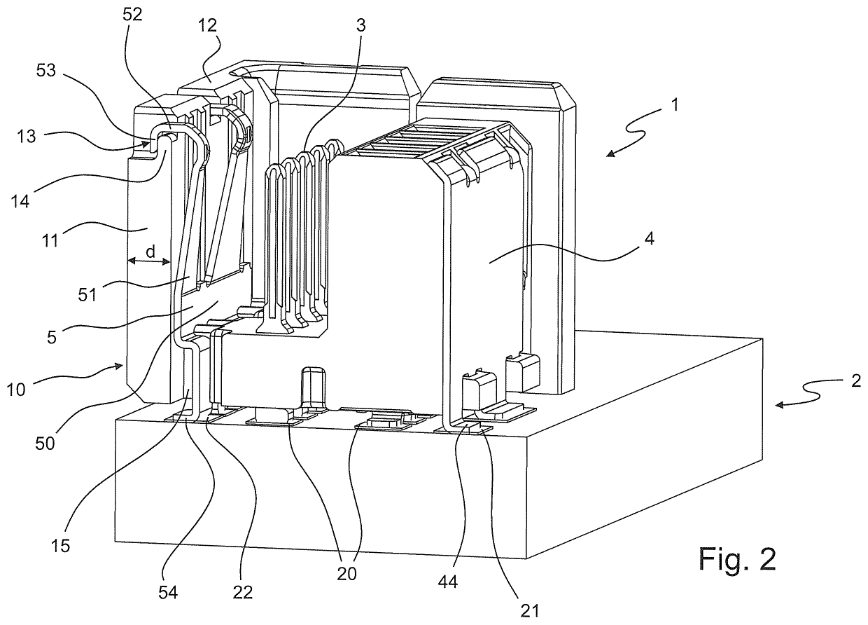

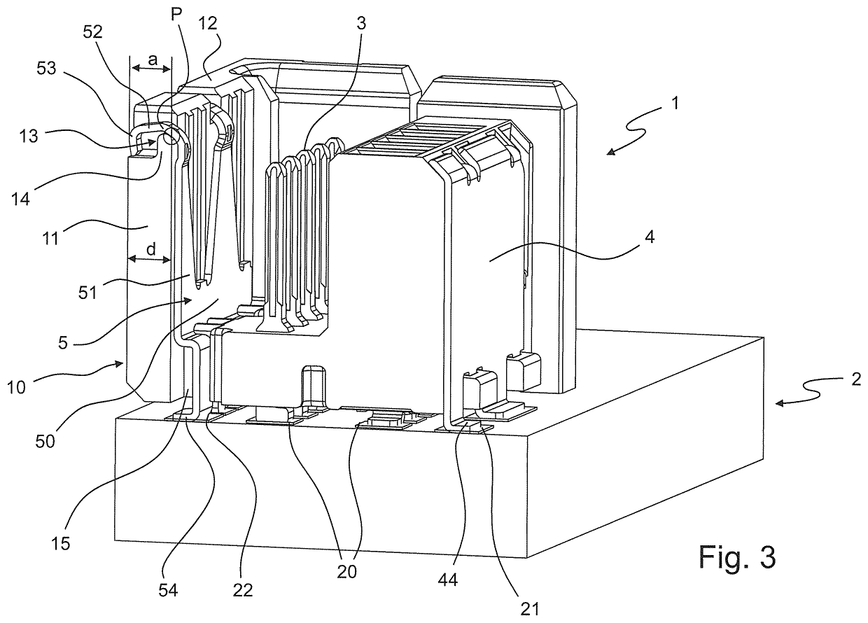

A pair of shield plates 4 and 5 are provided in connector 1, as shown in FIG. 1. The shield plates 4, 5 consist of metal or a metal alloy, such as a copper sheet, and in a contact region have a metal coating suitable for electrical contacts, such as palladium. In a soldering region, shield plates 4, 5 may have a tin coating. A first shield plate 4 is arranged on a front outer side of connector housing 10. A second shield plate 5 is arranged on a rear inner side of connector housing 10. The second shield plate 5 is held on connector housing 10 in this first embodiment by way of a plurality of fastening hooks 53. Second shield plate 5 is described hereafter with reference to FIGS. 2 and 3. Identical elements are identified with the same reference characters, and they shall be described only once hereafter.

FIGS. 2 and 3 show an isometric sectional view of connector 1 along section line X-X in FIG. 1. In FIG. 2, connector 1 is shown in a non-plugged state, i.e., no mating connector is plugged in. In FIG. 3, the connector is shown in a plugged state, i.e., a mating connector is plugged through the plug opening into connector 1 and is contacted by contact elements 3, without the mating connector itself being shown for reasons of clarity. In this embodiment, the mating connector can be configured in the same way as connector 1.

Second shield plate 5 comprises a base section 50, as shown in FIGS. 2 and 3. A plurality of spring contact elements 51 are arranged towards a top at the base section 50 and in this embodiment have a triangular shape. The spring contact elements 51 are arranged on a side of the shield plate 5 that points in the direction of the plug opening. Spring contact elements 51 are pre-tensioned inwardly in a direction of a center or interior of the connector 1, i.e., towards contact elements 3, and protrude from connector housing 10 in this direction, forming a curved edge towards the base section 50. As a result, the spring contact elements 51 are positioned as close as possible to the contact elements 3 and can be pushed outwardly by the mating connector when the latter is plugged in.

As shown in FIGS. 2 and 3, at an upper end, in the direction of the plug opening, each spring contact element 51 has an arcuate section 52 which is curved outwardly. A fastening hook 53 is formed at the end of arcuate section 52 and in turn points downwardly in the direction of circuit board 2. Base section 50 of second shield plate 5 abuts against a rear connector housing wall 11 of connector housing 10. In this embodiment, housing wall 11 is formed to be straight and has two substantially parallel surfaces on the inner side and on the outer side between which thickness d of housing wall 11 or of connector housing 10 is defined. On an upper outer edge 12, which surrounds the plug opening, the connector housing wall 11 has a plurality of recesses 13. The number and position of recesses 13 correspond to those of the spring contact elements 51. Each recess 13 has an upwardly projecting web 14 on the inner side. The web 14 is shorter than connector housing wall 11 and does not reach the upper outer edge 12 of the connector housing 10.

The description below is based on an exemplary spring contact element 51 of second shield plate 5 and a corresponding recess 13 in connector housing 10.

Arcuate section 52 extends from the end of spring contact element 51 from the interior of connector 1, runs over web 14 or extends around web 14 and into recess 13 so that fastening hook 53 protrudes engaging over web 14 into recess 13, as shown in FIGS. 2 and 3. Arcuate section 52 runs from the inner side around the web 14 and does not protrude beyond the upper outer edge 12. The arcuate section 52 runs over the web 14 in the opposite direction to the plugging direction. The fastening element 53 is arranged at the end of the arcuate section 52.

The at least one fastening element 53 of the at least one spring contact element 51 engages in the at least one recess 13 but is not fixed therein but can move outwardly in at least one, or in exactly one direction (in addition to the direction of insertion) and in the direction perpendicular to the housing wall 11. As a result, the spring contact elements 51 can be deflected without the fastening preventing the deflection or the fastening being released by the deflection.

In the non-plugged state shown in FIG. 2, when no mating connector is plugged into the connector 1, the fastening hook 53 or fastening element 53 is pressed against web 14 due to the pre-tension of spring contact elements 51 and abuts with its inner side against the outer side of web 14. This achieves a first fastening of shield plate 50 which prevents spring contact element 51 from tilting inwardly. The at least one web 14 prevents the at least one spring contact element 51 from being moved or dropping into the interior of the connector 1, i.e., in the direction of the center of the connector 1. Even during the plugging process, when a mating connector is just touching the at least one spring contact element 51, the at least one web 14 prevents the at least one spring contact element 51 from being moved or tilted into the interior of the connector 1.

FIGS. 2 and 3 show circuit board 2 with various soldering points 20, 21, 22. Contact elements 3 are soldered to first soldering points 20 and thus establish an electrical and mechanical connection to circuit board 2. First soldering points 20 for data transfer are contacted on or within circuit board 2. Second soldering points 21 and third soldering points 22 are contacted such that shielding can be conducted via them. First shield plate 4 is soldered to second soldering points 21 by way of soldering pads 44 on the underside.

Connector housing 10 has a fastening shoulder 15, shown in FIGS. 2 and 3, that protrudes from rear connector housing wall 11 and extends parallel thereto over the entire width of housing wall 11. The fastening shoulder 15 may also be referred to as a positioning element. The positioning element 15 may be arranged on a side on which the connector 1 is connected to an electronic component, such as the circuit board 2.

Base section 50 of second shield plate 5 rests downwardly on fastening shoulder 15 of connector housing 10 and is curved according to the shape of fastening shoulder 15. The fastening shoulder 15, in an embodiment, extends over the entire width of the connector housing 1 and the shield plate 5 rests along its entire width on the fastening shoulder 15.

In addition, second shield plate 5 has a plurality of soldering pads 54 which are arranged on the curved section of base section 50 and extend downwardly through a first opening of fastening shoulder 15. Soldering pads 54 are each soldered to third soldering points 22 of circuit board 2. This achieves, firstly, an electrical contact between second shield plate 5 and circuit board 2 and, secondly, a fastening of second shield plate 5 onto circuit board 2 and to connector housing 10. In addition, second shield plate 5 between soldering pads 54 has elongate sections which engage in second openings of fastening shoulder 15. Reference is made in this context to the description of the second embodiment. This creates a further fastening of second shield plate 5 to connector housing 10.

In the plugged state shown in FIG. 3, spring contact elements 51 of second shield plate 5 are deflected by the mating connector and abut against the inner side of connector housing wall 11. In this embodiment, spring contact element 51 abuts against inner side of web 14 at least at point P with arcuate section 52. Fastening hook 53 moves outwardly in recess 13 and is spaced from the web 14. Arcuate section 52 is configured such that distance a perpendicular to the surface of housing wall 11 between the outer side of fastening hook 53 and point P corresponds to thickness d of housing wall 11. Even when spring contact elements 51 abut against connector housing 10, at maximum deflection, fastening hook 53 then remains within recess 13 and does not protrude from connector housing 10. At the same time, the fastening element 53 can move as far as possible within the recess 13 and the spring contact element 51 can therefore be deflected as far as possible. Distance a minus the thickness of web 14 and the thickness of fastening hook 53 corresponds to the maximum deflection of spring contact elements 51 in the direction of the center of the connector.

The at least one fastening element 53 and the at least one recess 13 are matched to one another such that the fastening element 53 does not protrude outwardly beyond the connector housing 10 in the direction opposite direction to the plugging direction and in particular not in the maximum deflected state of the spring contact elements 51. Consequently, the installation space for the connector 1 is not increased by the fastening.

It is realized as a result by the spring-mounted spring contact element 51 and the hooking into the recess 13 in the connector housing 1, which enables a motion of the spring contact element 51, that the spring contact element 51 is retained securely and cannot drop inwardly, but at the same time can move outwardly, and namely only so far that it does not protrude from the connector housing 1. Since the spring contact element 51 does not protrude from the connector housing 1, the risk of bending due to external mechanical influences in any direction is greatly reduced.

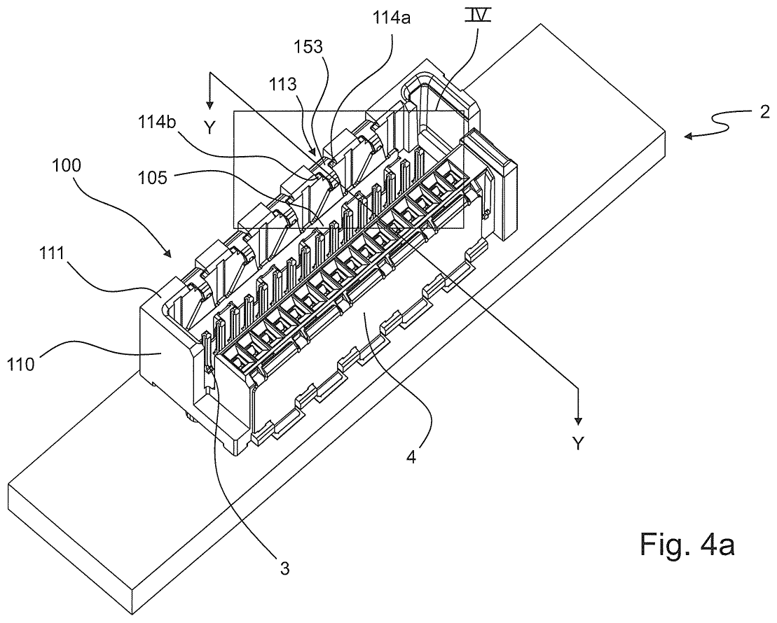

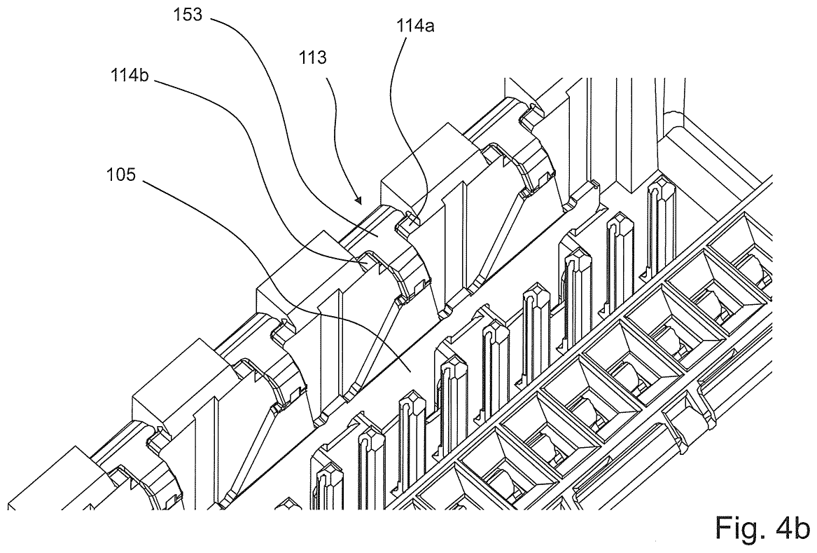

FIG. 4a shows an isometric view of a second embodiment of connector 100 according to the invention which is fastened to a circuit board 2 as an SMD (surface-mounted device). FIG. 4b shows a detailed view of section IV from FIG. 4a. Connector 100 likewise comprises a plurality of contact elements 3 which are contacted via circuit board 2. In addition, the connector 100 comprises a connector housing 110 that, on an upper side disposed opposite the circuit board, has a plug opening through which contact elements 3 are accessible from the outside. Two shield plates 4 and 105 are provided in connector 1. The second embodiment differs from the first embodiment in the fastening of second shield plate 105. Circuit board 2 with soldering points 20, 21, 22, contact elements 3, and first shield plate 4 as well as their contacting correspond to the first embodiment and reference is made to the above description.

The second shield plate 105 is arranged on the rear inner side of connector housing 110. In this second embodiment, it is retained at connector housing 110 by way of T-shaped fastening elements 153. Connector housing wall 11 has a plurality of recesses 113. Each recess 113 on the inner side comprises two upwardly projecting webs 114a and 114b, as shown in FIG. 4b, where one of two webs 114a is arranged on the right-hand side of recess 113 and other web 114b on the left-hand side of recess 113. There is a gap between webs 114a, 114b through which T-shaped fastening element 153 is guided into recess 113. T-shaped fastening element 153 has two angled sections that are angled in opposite directions. One angled section each engages behind one of webs 114a, 114b. This ensures secure retention, in particular against the fastening element 153 being unscrewed. In principle, only one of the angled sections can engage behind a web 114a, 114b.

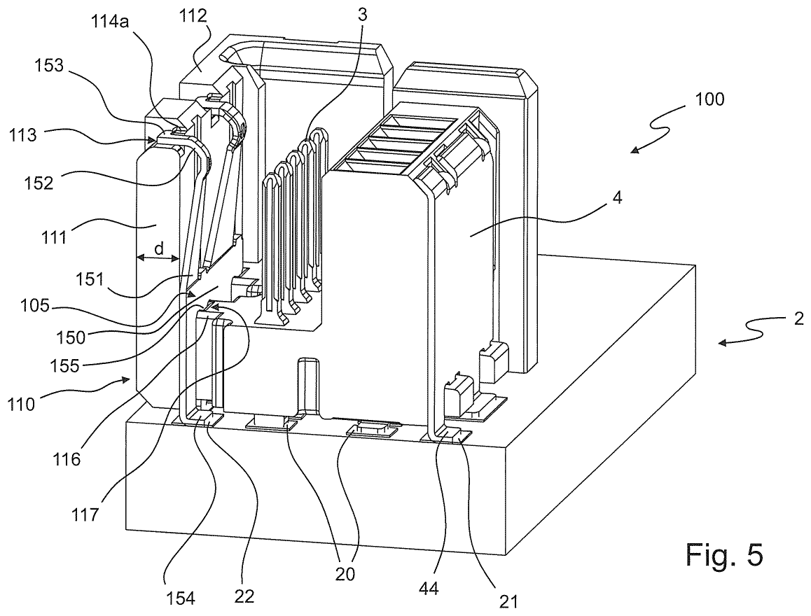

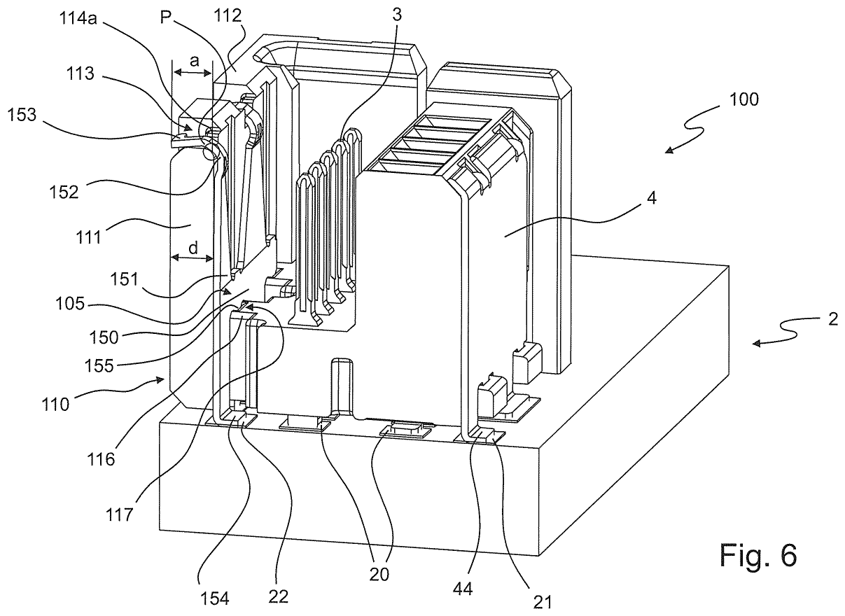

FIGS. 5 and 6 show an isometric sectional view of connector 100 along section line Y-Y in FIG. 4a. Connector 100 is shown in FIG. 5 in the non-plugged state and in FIG. 6 in the plugged state, where the mating connector is not shown for reasons of clarity. In this embodiment, the mating connector can be configured in the same way as connector 100.

Second shield plate 105 comprises a base section 150, as shown in FIGS. 5 and 6. A plurality of spring contact elements 151 are arranged towards the top at this base section 150 and in this embodiment have a triangular shape. Spring contact elements 151 are pre-tensioned inwardly in the direction of the center of the connector, i.e., towards contact elements 3, and protrude from connector housing 110 in this direction, forming a curved edge towards base section 150. At the upper end, in the direction of the plug opening, each spring contact element 151 has a curved section 152 which is curved outwardly. T-shaped fastening element 153 is formed at the end of curved section 152. Due to the section, only an angled section of T-shaped fastening element 153 can be seen in the illustration. Base section 150 of second shield plate 105 abuts against a rear connector housing wall 111 of connector housing 110. In this embodiment, housing wall 111 is formed to be straight and has two substantially parallel surfaces on the inner side and on the outer side between which thickness d of housing wall 111 or of connector housing 110 is defined. Several recesses 113 are arranged on upper outer edge 112 of connector housing wall 111 which surrounds the plug opening. The number and position of recesses 113 correspond to those of spring contact elements 151.

The description hereafter is based on an exemplary spring contact element 151 of second shield plate 105 and a corresponding recess 113 in connector housing 110.

As already described above, each recess 113 comprises two webs 114a, 114b (of which only one is visible by the section in FIGS. 5 and 6) which are arranged on the sides of recess 113. A gap is formed between two webs 114a, 114b. A main section of T-shaped fastening element 153 connected to curved section 152 is guided coming from the inner side through this gap into recess 113 where it then branches into the two sections angled at an angle of 90°. The angled sections are formed disposed opposite each other in opposite directions, lie in a plane with the main section, and extend into recess 113. T-shaped fastening element 153 does not protrude beyond outer edge 112 of connector housing 110.

In the non-plugged state shown in FIG. 5, T-shaped fastening element 153 is pressed against webs 114a, 114b due to the pre-tension of spring contact elements 151. The angled section at the right abuts with its inner side against the outer side of the web 114a at the right and angled section at the left abuts with its inner side against the outer side of the web 114b at the left (the latter can only be seen in FIG. 4, but not in FIGS. 5 and 6). This achieves a first fastening of shield plate 150 which prevents spring contact element 151 from tilting inwardly.

Since neither curved section 152 nor fastening element 153 are guided above webs 114a, 114b, the height of webs 114a, 114b can be selected substantially arbitrarily with the restriction that webs 114a, 114b be high enough to hold fastening element 153 against the pre-tension of spring elements 151 in recess 113, even if fastening element 153 does not rest on the bottom of recess 113, as shown in FIG. 5. In the non-plugged state, fastening element 153 is held at a height such that it can pivot downwardly when deflected during the plugging process.

In the plugged state shown in FIG. 6, spring contact elements 151 of second shield plate 105 are deflected by the mating connector and abut against the inner side of connector housing wall 111. In this embodiment, spring contact element 151 abuts at least at point P with curved section 152 against the inner side of connector housing wall 111. T-shaped fastening element 153 moves outwardly in recess 113 and in the process pivots downwardly. T-shaped fastening element 153 and curved section 152 are configured such that distance a perpendicular to the surface of housing wall 111 between the outer side of T-shaped fastening element 153 and point P corresponds to thickness d of housing wall 111. Even when spring contact elements 151 abut against connector housing 110, fastening element 153 remains within recess 113 and does not protrude from connector housing 110. Distance a minus the thickness of web 114a or 114b and the width of the angled section of T-shaped fastening hook 153 corresponds to the maximum deflection of spring contact elements 151 in the direction of the center of the connector 100.

To realize a further fastening, connector housing 110 has a plurality of supports 116 that protrude vertically or perpendicularly from connector housing wall 111, as shown in FIGS. 5 and 6. The supports 116 may also be referred to as a positioning element.

Base section 150 of second shield plate 105 bears downwardly on supports 116. In addition, second shield plate 105 has a plurality of soldering pads 154 that are arranged on the underside of base section 150. Soldering pads 154 run laterally past supports 116 and enclose them. Soldering pads 154 are each soldered to third soldering points 22 of circuit board 2. This achieves, firstly, an electrical contact between second shield plate 105 and circuit board 2 and, secondly, a fastening of second shield plate 105 onto circuit board 2 and to connector housing 110. In addition, second shield plate 105 between soldering pads 54 has a plurality of elongate sections 155 which engage in openings 117 of supports 116. Elongate sections 155 can comprise fastening elements that engage in complementary fastening elements in openings 117 while the supports 116 fit in recesses of the shield plate 105. This creates a further fastening of second shield plate 105 to connector housing 110.

The supports 116 can be used in the first embodiment in addition to the fastening shoulder or instead of it to implement the further fastening. In the second embodiment and in the third and fourth embodiments described hereafter, the fastening shoulder 15 according to the first embodiment can also be used as a further fastening.

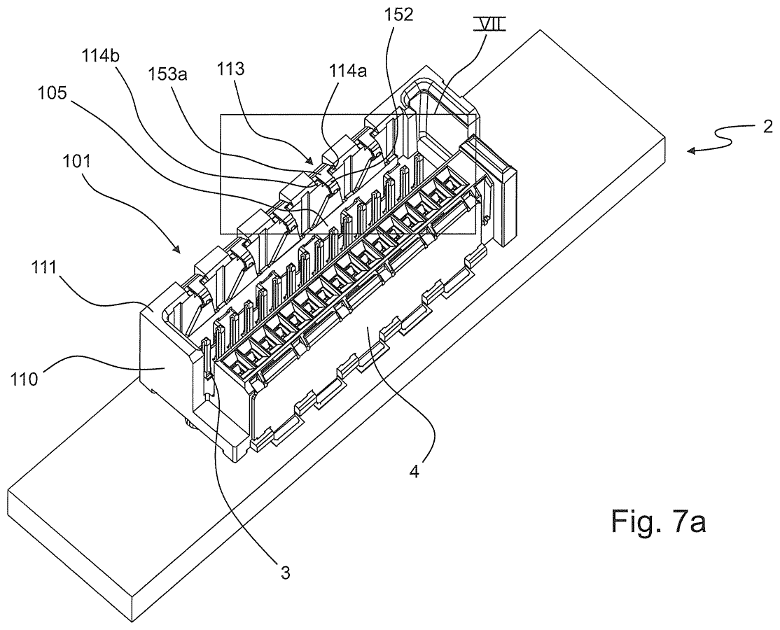

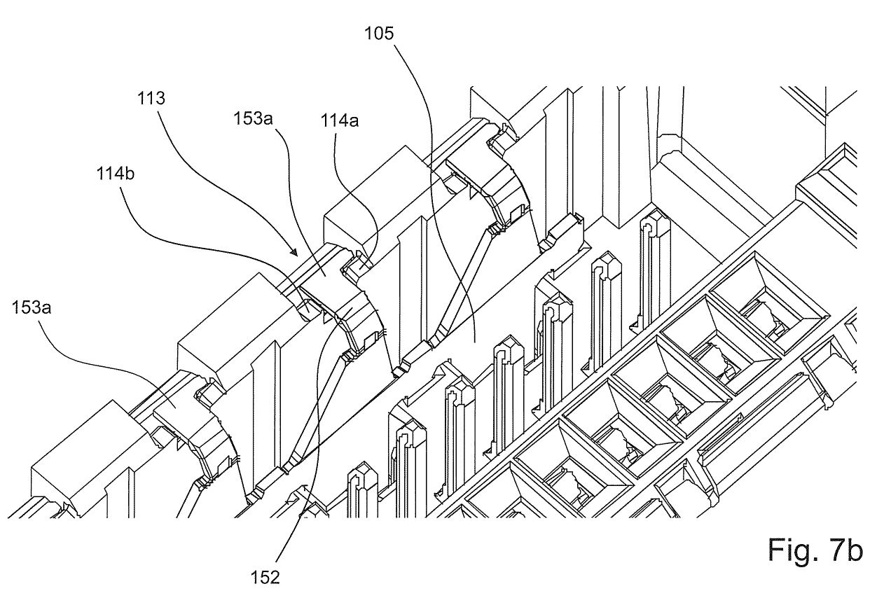

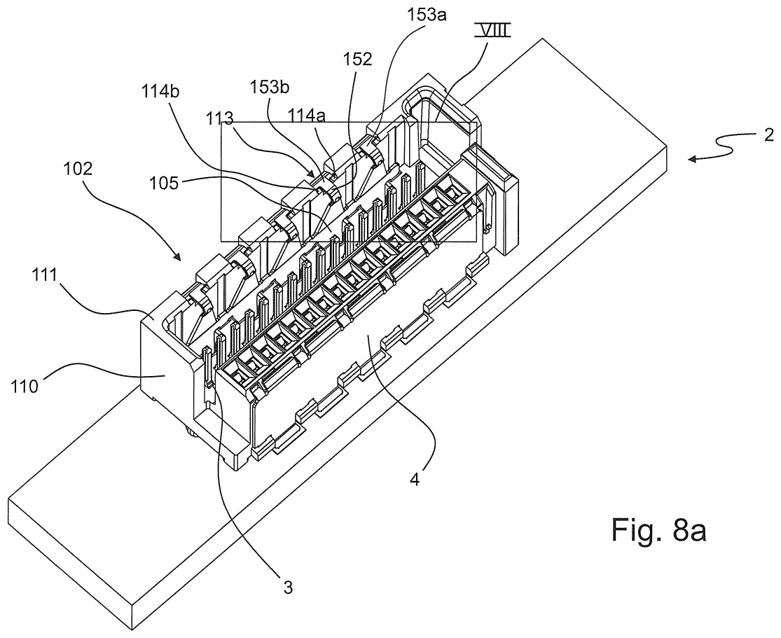

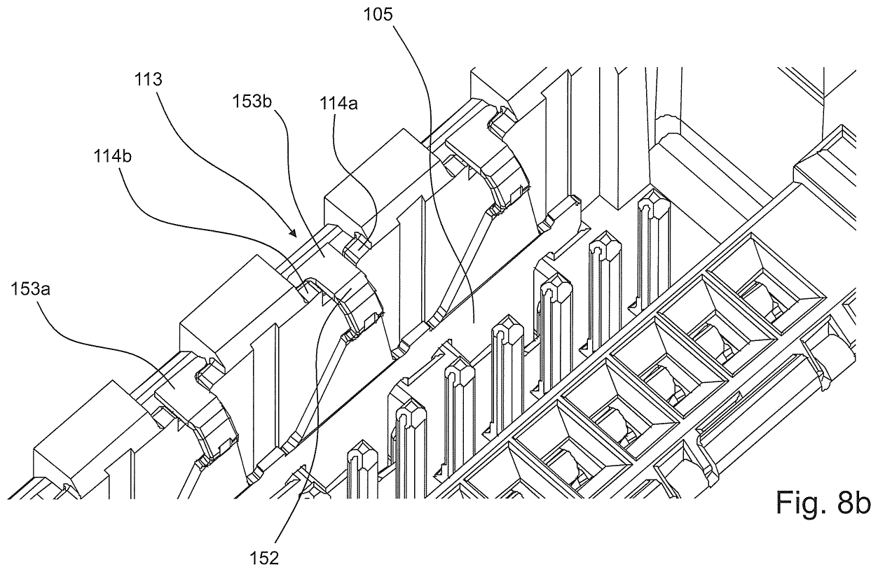

FIGS. 7a and 7b show a third embodiment of connector 101 according to the invention, where FIG. 7b shows a detailed view of section VII from FIG. 7a. FIGS. 8a and 8b show a fourth embodiment of connector 102 according to the invention, where FIG. 8b shows a detailed view of section VII from FIG. 8a. The third embodiment and the fourth embodiment differ from the second embodiment in that the fastening elements are configured as L-shaped fastening elements 153a, 153b. L-shaped fastening elements 153a, 153b each have a section angled at an angle of 90°. The angled section lies in a plane with the main section and extends in one direction into recess 113. L-shaped fastening element 153a, 153b does not protrude beyond outer edge 112.

Fastening elements angled to the right are designated by 153a and fastening elements angled to the left are designated by 153b in FIGS. 7a-8b. The directions in which the L-shaped fastening elements 153a, 153b are angled can be selected substantially freely. An embodiment is described hereafter with which a first fastening of the shield plate 105 is achieved and which prevents spring contact element 151 from tilting inwardly.

In the third embodiment in FIGS. 7a and 7b, L-shaped fastening elements 153a are angled in the same direction, namely to the right in this example—a configuration with fastening elements only angled to the left is also possible. All L-shaped fastening elements 153a are therefore configured identically, which simplifies series production. In this embodiment, recess 113 in connector housing 110 also comprises two webs 114a, 114b each. In other embodiments, a web 114a may be provided only on the side to which L-shaped fastening element 153a is angled. In the non-plugged state, L-shaped fastening element 153a is pressed against web 114a on the right due to the pre-tension of spring contact elements 151 and the angled section abuts with its inner side against the outer side of web 114a on the right.

In the fourth embodiment in FIGS. 8a and 8b, adjacent L-shaped fastening elements 153a, 153b are angled alternately so that an L-shaped fastening element 153a angled to the right is arranged next to an L-shaped fastening element 153b angled to the left. In this embodiment, recesses 113 in connector housing 110 furthermore comprise two webs 114a, 114b each. In other embodiments, a web 114a or 114b can be provided for each recess 113 only on the side to which L-shaped fastening element 153a or 153b is angled. In the non-plugged state, L-shaped fastening element 153a angled to the right is pressed against web 151 on the right due to the pre-tension of spring contact elements 151 and the angled section abuts with its inner side against the outer side of web 114a on the right.

Similarly, an L-shaped fastening element 153b angled to the left is pressed against web 114b on the left due to the pre-tension of spring contact elements 151 and the angled section abuts with its inner side against the outer side of web 114b on the left. The alternating arrangement ensures secure retention, in particular against being unscrewed.

In the above embodiments, a straight connector 1, 100, 101, 102 is illustrated. The above features can also be adopted for an angled connector.

1. A connector, comprising:
a connector housing having a plug opening, a recess on a side of the plug opening, and a web on a side of the recess facing an interior of the connector; and
a shield plate arranged on an inner side of the connector housing, the shield plate has a spring contact element with a fastening element, the fastening element is positioned in the recess, the fastening element abuts against the web in a non-plugged state of the connector and is spaced from the web in a plugged state of the connector, the fastening element does not protrude from the recess.

2. The connector of claim 1, wherein the fastening element in the plugged state is spaced from the web by deflection of the spring contact element.

3. The connector of claim 1, wherein the fastening element does not protrude from the recess in both the non-plugged state and in the plugged state.

4. The connector of claim 1, wherein the spring contact element has an arcuate section that extends around the web.

5. The connector of claim 4, wherein the fastening element is a fastening hook at an end of the arcuate section.

6. The connector of claim 1, wherein the spring contact element has an angled fastening element that engages behind the web.

7. The connector of claim 6, wherein the spring contact element is a T-shaped fastening element that engages behind the web.

8. The connector of claim 6, wherein the spring contact element is an L-shaped fastening element that engages behind the web.

9. The connector of claim 1, wherein a section of the spring contact element abuts against an inner side of the web in the plugged state.

10. The connector of claim 9, wherein a distance between an outer side of the fastening element and a point at which the spring contact element abuts against the web in the plugged state corresponds to a thickness of the connector housing.

11. The connector of claim 1, wherein a section of the spring contact element abuts against the inner side of the connector housing in the plugged state.

12. The connector of claim 11, wherein a distance between an outer side of the fastening element and a point at which the spring contact element abuts against the connector housing in the plugged state corresponds to a thickness of the connector housing.

13. The connector of claim 1, wherein the spring contact element is pre-tensioned in a direction of the interior of the connector.

14. The connector of claim 1, wherein the shield plate rests on a positioning element of the housing.

15. The connector of claim 14, wherein the positioning element protrudes from a wall of the connector housing having the web.

16. The connector of claim 15, wherein the positioning element is a fastening shoulder that extends over an entire width of the wall of the connector housing.

17. The connector of claim 15, wherein the positioning element is a plurality of supports that are spaced apart by openings.

18. The connector of claim 1, wherein the shield plate has a soldering pad connecting to a circuit board.
